(19) United States
(12) Patent Application Publication
(10) Pub. No.: US 2024/0396835 A1
(43) Pub. Date: Nov. 28, 2024

(54) METHOD AND APPARATUS FOR CONSTRUCTING MULTI-STAGE HASH TABLE

(71) Applicant: Electronics and Telecommunications Research Institute, Daejeon (KR)

(72) Inventor: Sung Hyuk BYUN, Daejeon (KR)

(21) Appl. No.: 18/674,602

(22) Filed: May 24, 2024

(30) Foreign Application Priority Data
May 25, 2023 (KR) 10-2023-0067411

(51) Int. Cl. H04L 45/7453

(52) U.S. Cl. CPC H04L 45/7453

(57) ABSTRACT

A method and an apparatus for constructing a multi-stage hash table are disclosed. According to an embodiment of a present disclosure, a method for constructing a multi-stage hash table includes attempting to add management table information to a first management table and attempting to add hash table information to a first hash table. The method also includes determining whether second management table information having the same hash value as a hash value included in first management table information is present in a k-th management table. The method also includes attempting to add table information to the k-th management table and a k-th hash table or to a (k+1)-th management table and a (k+1)-th hash table based on the determination result.

### CROSS-REFERENCE TO RELATED APPLICATIONS

The present application is based on, and claims priority from, Korean Patent Application Number 10-2023-0067411, filed May 25, 2023, the disclosure of which is incorporated by reference herein in its entirety.

### TECHNICAL FIELD

The present disclosure relates to a method and apparatus for constructing a multi-stage hash table. More specifically, the present disclosure relates to a method and apparatus for resolving hash collisions using a multi-stage hash table and a multi-stage management table without storing large key values in entries of the hash table.

### BACKGROUND

The contents described below merely provide background information related to the present disclosure and do not constitute prior art.

Hash tables are common technology used to store and manage a large number of (key, value) pairs in a memory-efficient manner. In hash tables, hash collisions can occur when the hash values of keys are the same or entry storage slots are the same. To resolve the hash collision, each key needs to be stored in hash table entries. However, if the key size is very large or have a variable length, a lot of memories is required to store the keys in entries. Accordingly, there are limitations that make it difficult to construct a hash table with hardware having a limited memory. A representative example of such limitations is a case in which a forwarding engine of a named data network (NDN) is implemented using a hash table.

NDN can be said to be a representative technology of an information centric network (ICN) for realizing future Internet architectures. NDN performs forwarding using a data name itself rather than a host IP address containing specific data. A data name has a variable length and has no length limit. A hash table can be used to speed up forwarding using such a variable-length name. A hash table creates a fixed-length hash value by hashing a variable-length key. An entry is stored in a k-th slot, which is the remainder of dividing the hash value by the number of slots in the hash table. In a hash table, the hash values of different entries may be the same, and multiple entries may be stored in the same slot even if the hash values are different. To resolve such a hash collision, a key may be included in entry information to check whether the entry has the same key.

In a case in which a forwarding information base (FIB) is implemented with hash table in NDN, a variable-length prefix serves as a key, and thus the prefix is stored in entries. When a forwarding engine is implemented in software, memories of different sizes may be allocated for respective entries. However, when a forwarding engine is implemented in hardware for high-speed forwarding, it may be difficult to implement entries while reducing memory waste. To solve this, the maximum size prefix may be limited and all entries may be set to maximum size entries. Alternatively, memory efficiency can be improved by using one memory block for small-length prefixes and multiple memory blocks for long prefixes. However, in this case, when designing the pipeline in hardware, the lookup time per entry must be allocated as much as the lookup time of the maximum size prefix. Accordingly, the lookup time increases and performance deteriorates.

### SUMMARY

The present disclosure can resolve hash collisions by storing only fixed-length hash values in entries of a hash table without storing large key values.

In addition, according to one embodiment, a multi-stage hash table with different hash functions can be configured to resolve hash collisions.

Further, according to one embodiment, a hash table manager can determine hash collisions by storing key values in a management table.

Furthermore, according to one embodiment, memory efficiency can be improved and forwarding performance can be enhanced by using a multi-stage hash table.

The objects to be achieved by the present disclosure are not limited to the objects mentioned above, and other objects not mentioned will be clearly understood by those skilled in the art from the description below.

According to the present disclosure, a method for configuring a multi-stage hash table includes attempting to add management table information to a first management table and attempting to add hash table information to a first hash table. The method also includes determining whether second management table information having the same hash value as a hash value included in first management table information is present in a k-th management table. The first management table information is information to be added to the k-th management table. The method also includes attempting to add table information to the k-th management table and a k-th hash table or to a (k+1)-th management table and a (k+1)-th hash table based on the determination result. table information added to the k-th hash table and the (k+1)-th hash table does not include a key.

According to the present disclosure, an apparatus for configuring a multi-stage hash table includes a memory and a plurality of processors. At least one of the plurality of processors is configured to attempt to add management table information to a first management table and attempt to add hash table information to a first hash table. The at least one of the plurality of processors is also configured to determine whether second management table information having the same hash value as a hash value included in first management table information is present in a k-th management table. The first management table information is information to be added to the k-th management table. The at least one of the plurality of processors is also configured to attempt to add table information to the k-th management table and a k-th hash table or to a (k+1)-th management table and a (k+1)-th hash table based on the determination result. table information added to the k-th hash table and the (k+1)-th hash table does not include a key.

According to the present disclosure, a computer-readable recording medium is a computer-readable recording medium storing instructions, the instructions, when executed by the computer, may cause the computer to perform attempting to add management table information to a first management table and attempting to add hash table information to a first hash table. The instructions, when executed by the computer, may also cause the computer to perform determining whether second management table information having the same hash value as a hash value included in first management table information is present in a k-th management table. The first management table information is information to be added to the k-th management table. The instructions, when executed by the computer, may also cause the computer to perform attempting to add table information to the k-th management table and a k-th hash table or to a (k+1)-th management table and a (k+1)-th hash table based on the determination result. table information added to the k-th hash table and the (k+1)-th hash table does not include a key.

According to the present disclosure, it is possible to resolve hash collisions by storing only fixed-length hash values in entries of a hash table without storing key values.

In addition, according to one embodiment, it is possible to construct a multi-stage hash table with different hash functions to resolve hash collisions.

Further, according to one embodiment, a hash table manager can determine hash collisions by storing key values in a management table.

Furthermore, according to one embodiment, it is possible to improve memory efficiency and forwarding performance by using a multi-stage hash table.

The effects of the present disclosure are not limited to the effects mentioned above, and other effects not mentioned will be clearly understood by one of ordinary skill in the art from the following description.

### BRIEF DESCRIPTION OF THE DRAWINGS

FIG. 1 is a diagram illustrating the structure of a general hash table based on a linked list.

FIG. 2 is a block diagram of an apparatus composed of a multi-stage hash table and a multi-stage management table according to an embodiment of the present disclosure.

FIG. 3 is a block diagram of a packet forwarding device composed of a multi-stage hash table and a multi-stage management table according to another embodiment of the present disclosure.

FIG. 4A and FIG. 4B are diagrams illustrating an entry format of a management table and an entry format of a hash table according to an embodiment of the present disclosure.

FIG. 5 is a diagram illustrating a method of storing entries with hash collisions in a three-stage hash table in a management table according to an embodiment of the present disclosure.

FIG. 6 is a diagram illustrating a process of adding a new entry according to an embodiment of the present disclosure.

FIG. 7 is a diagram illustrating a process of looking up a hash table according to an embodiment of the present disclosure.

FIG. 8 is a diagram illustrating a method of configuring a multi-stage hash table according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure, and is not intended to represent the only embodiments in which the present disclosure may be practiced.

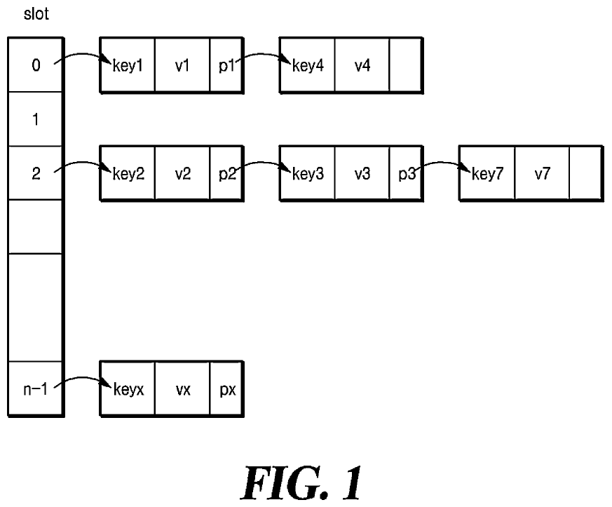

FIG. 1 is a diagram illustrating the structure of a general hash table based on a linked list.

Referring to FIG. 1, a hash table can be used to store entries containing keys and values. Entries need to store keys to resolve hash collisions. A hash value may correspond to a value H(key) obtained by hashing a key with an appropriate hash function H( ). A value k can be calculated by performing a modular operation on a hash value to a table size. Accordingly, the key and the hash value can be stored in the k-th slot. Multiple entries with the same hash value can be stored in the same slot. Multiple entries having the same modular calculation value of hash values to a table size although the hash values are different can be stored in the same slot. A linked list can be used as a method of storing multiple entries in one slot.

In the case of looking up a hash table, it is necessary to compare keys in order to check whether a matching entry is the entry for a desired key. This is because two or more keys in a hash table can have the same hash value. Accordingly, it is necessary to store keys in a hash table. However, as the key size increases, the memory capacity for storing keys increases, and when a hash table is implemented using hardware such as an ASIC or an FPGA, it may be difficult to implement a hash table due to limitations on a memory size per entry and overall table memory. In particular, in the case of variable-length keys, a key memory of an entry is allocated to a maximum allowable key size, which also causes inefficient use of the memory.

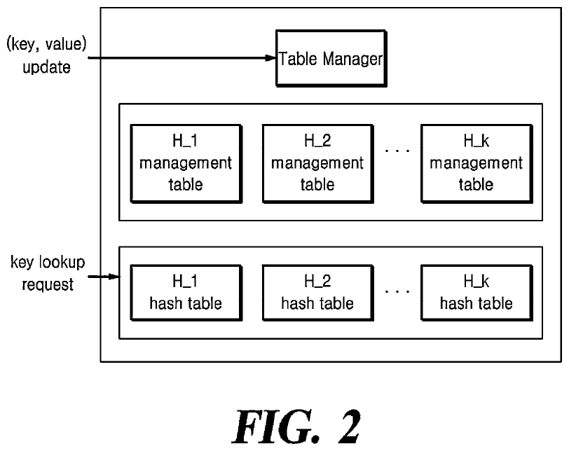

FIG. 2 is a block diagram of an apparatus composed of a multi-stage hash table and a multi-stage management table according to an embodiment of the present disclosure.

Referring to FIG. 2, a hash table group may include k hash tables based on k independent hash functions. A table manager may manage k management tables corresponding to the respective hash tables in the hash table group. There may be k management tables based on k independent hash functions. The number k of hash table stages may be determined to resolve hash collisions in consideration of the hash functions and the number of entries. The table manager may add, delete, or update entries. In this case, the hash tables of the hash table group and the management tables may be modified. As an example, a hash table H_1 may be managed by a management table H_1. The hash function of the hash table H_1 may be the same as the hash function of the management table H_1. The table manager may update keys and values stored in entries. The table manager may request a lookup to find entries that match the hash table group.

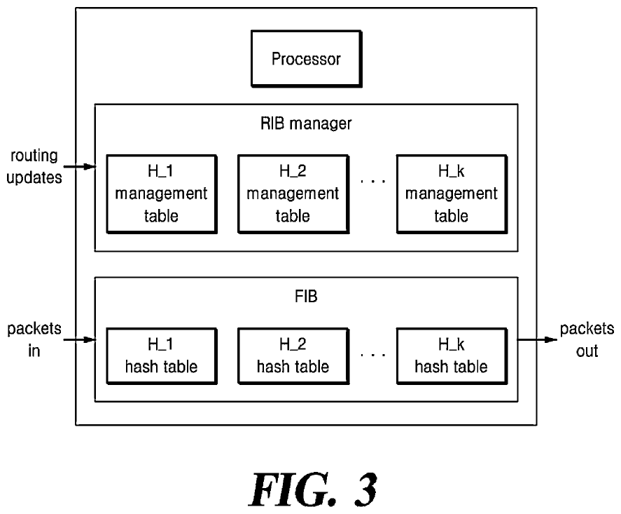

FIG. 3 is a block diagram of a packet forwarding device composed of a multi-stage hash table and a multi-stage management table according to another embodiment of the present disclosure. Hash tables using variable-length keys are often used to implement FIB of NDN. FIB of NDN uses a data name-based variable-length prefix as a key. In theory, there is no limit to the prefix length, and it can be implemented by limiting a maximum size that can be supported by a router system. When a hash table-based NDN FIB is implemented in software, the performance may deteriorate, but there are few restrictions on storing variable-length prefixes as keys. When the NDN FIB is implemented in hardware for high-speed forwarding, a lookup time is fixed to a maximum value, which may have the disadvantage of increasing the lookup time for a short-length prefix.

When a hash table is implemented using hardware, memory allocation may be designed for each entry. In this case, a memory having the maximum size is allocated to the prefix and a comparison logic is designed to suit the maximum size, which may result in memory waste. In the present disclosure, when the FIB is implemented as a hash table, a variable-length prefix, which is a key, may not be stored in the hash table, but a fixed-length hash value may be stored. A fixed-length hash value may be used as an entry delimiter. Accordingly, the entry size is reduced and the lookup time becomes constant, and thus the forwarding speed can increase. A multi-level hash table may be used to resolve hash collisions.

A hash table manager may construct a hash table group suitable for the system structure. As an example, a hash table manager may correspond to a routing information base (RIB) manager that manages routing entries using a routing protocol. Here, the RIB manager may be implemented as software in association with the routing protocol. As an example, FIB may be implemented using a hash table group. The hash table manager may include management tables corresponding to hash tables in a hash table group. A hash value and a prefix may be stored together in the management table. The hash table manager may use such a management table to manage hash collisions at the time of adding or deleting entries. The hash table manager may access the management table only when changing entries. Storing a variable-length prefix that is a key value in the management table does not affect forwarding performance. This is because only hash tables are used in packet forwarding.

Referring to FIG. 3, a hash table group may have k hash tables based on k independent hash functions. A hash table manager may include k management tables corresponding to the respective hash tables in the hash table group. The number k of hash table stages needs to be determined to resolve hash collisions in consideration of the number of hash functions and the number of entries. For example, if the hash table manager is an RIB manager, the hash table manager may add, delete, or update entries using a configuration method such as a routing protocol or a command line interface (CLI). In this case, the hash tables of the hash table group and the management tables of the hash table manager may be modified. For example, if the FIB is implemented using a hash table, a packet may be input to the FIB and a forwarding process may be performed.

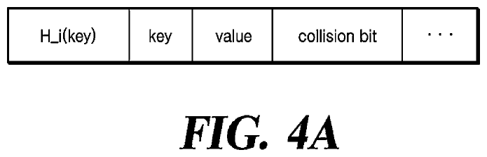

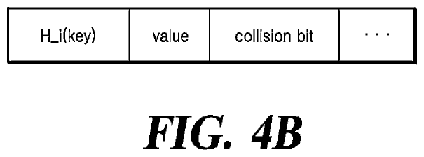

FIG. 4A and FIG. 4B are diagrams illustrating an entry format of a management table and an entry format of a hash table according to an embodiment of the present disclosure.

Referring to FIG. 4A, as an example, the entry structure of the management table may be composed of a hash value H_i(key), a key, a value, and a collision bit. The hash value H_i(key), key, value, and collision bit may refer to management table information. The Management table information may refer to content included in entries of the management table.

Referring to FIG. 4B, as an example, the entry structure of the hash table may be composed of a hash value H_i(key), a value, and a collision bit. The hash value H_i(key), value, and collision bit may refer to hash table information of the hash table. The hash table information may refer to content included in entries. Unlike entries in the management table, entries in the hash table may not store keys. Accordingly, the hash table may be implemented with a fixed length. If a collision situation in which the hash value of an entry in the hash table is the same as the hash value of another entry occurs, the collision bit may be set to 1. If a collision situation does not occur, the conflict bit may be set to 0. Management table information and hash table information may refer to table information.

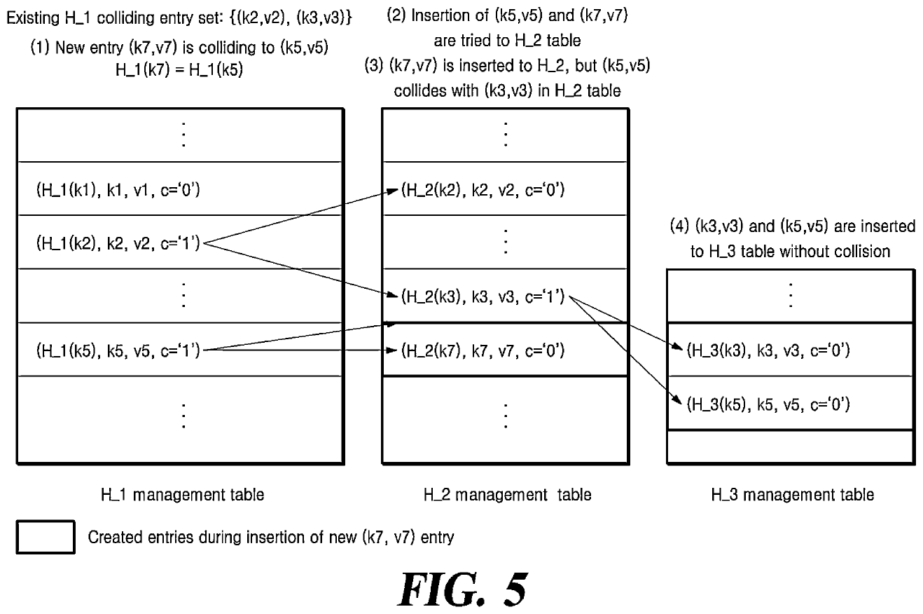

FIG. 5 is a diagram illustrating a method of storing entries with hash collisions in a three-stage hash table in a management table according to an embodiment of the present disclosure.

Referring to FIG. 5, a hash table group may be composed of hash tables in three stages. Management tables may also be composed of management tables in three stages. As an example, an entry stored in a management table may be represented as (H_i(k), k, v, c). With respect to information included in the entry, k indicates a key, H_i(k) indicates a hash value, v indicates a value, and c indicates a collision bit. Hash functions can generate random patterns. For example, if the number of output bits of a hash function is 64 bits and one million entries are added to the hash table, the probability of a hash collision is 2.8×10-8, which is a very low probability. The probability of a hash collision occurring in all of the management table H_1, management table H_2, and management table H_3 corresponds to the product of the probabilities of a hash collision occurring in the respective management tables. Accordingly, as the number of hash table stages increases, the probability of a hash collision converges to 0.

Since the number of entries in the management table H_2 is the number of entries with hash collisions in the management table H_1, the management table size rapidly decreases as the number of stages increases. For example, if the number of output bits of the hash function of the management table H_1 is 128 bits and one million entries are added to the management table H_1, the probability of a hash collision is 10-27. Accordingly, hash collisions can be avoided by substantially using only one management table. A small management table H_2 may be added to avoid hash collisions that may occur.

Since H_1(k2) and H_1(k3) are the same in the management table H_1, a hash collision between (k2,v2) and (k3,v3) may occur. Since H_1(k5) and H_1(k7) are the same in the management table H_1, a hash collision between (k5,v5) and (k7,v7) may occur. The number of a key indicates the order in which the key has been added to a management table. Since entries containing only hash values are stored in hash tables, in the event of a hash collision, only the collision bit of a previously stored entry can be set to 1. Here, a new entry may not be added to the management tables and the hash tables. Since an entry containing H_1(k2) and an entry containing H_1(k5) have been stored first without a hash collision, only the entry containing H_1(k2) and the entry containing H_1(k5) can be present in the management table H_1. In the management table H_1, only an entry containing k2 and H_1 (k2) and an entry containing k5 and H_1(k5) can be present.

The hash table manager may ascertain that there is a hash collision between (k2,v2) and (k3,v3) in the management table H_1 and add an entry containing H_1(k2) and an entry containing H_1(k3) to the management table H_2. The hash table manager may ascertain that there are a hash collision between (k5,v5) and (k7,v7) in the management table H_1 and a hash collision between (k3,v3) and (k5,v5) in the management table H_2, and may not add an entry containing H_2 (k5) to the management table H_2. The hash table manager may add an entry containing H_3 (k3) and an entry containing H_3 (k5) to the management table H_3.

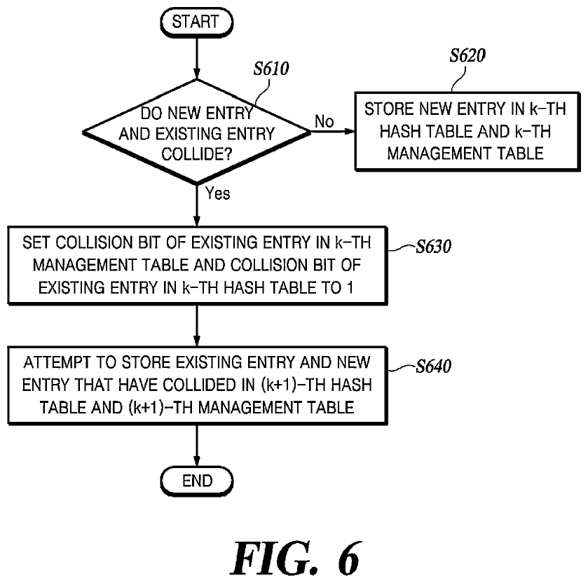

FIG. 6 is a diagram illustrating a process of adding a new entry according to an embodiment of the present disclosure.

Referring to FIG. 6, it may be determined whether a hash collision between a new entry and an existing entry occurs (S610). If an existing entry having the same hash value as a hash value to be stored in a new entry is present in a k-th management table, a hash collision between the new entry and the existing entry may occur. If no hash collision between a new entry and an existing entry occurs (S610—NO), the hash table manager may store the new entry in the k-th hash table and the k-th management table (S620). The new entry stored in the k-th hash table may not include a key. The new entry stored in the k-th management table may include a key. If a hash collision between the new entry and the existing entry occurs (S610—YES), the hash table manager may set the collision bit of the existing entries stored in the k-th management table and the collision bit of the existing entries stored in the k-th hash table to 1 (S630). In this case, the hash table manager may not store new entries in the k-th management table and the k-th hash table. The hash table manager may attempt to store the collided existing and new entries in the (k+1)-th hash table and the (k+1)-th management table (S640). Since the hash function of each hash table is independent, there is a low possibility of a hash collision between existing and new entries in the (k+1)-th hash table and the (k+1)-th management table.

If a hash collision between an existing entry and a new entry occurs in the (k+1)-th hash table and the (k+1)-th management table, the existing entry and the new entry may be stored in the (k+2)-th management table and the (k+2)-th hash table in the same manner. This method may be repeated up to n times, which is the number of hash table stages. The number of hash table stages may be fixed at the time of system initialization. If dynamic addition of a hash table is possible, such as in a software implementation, the number of hash table stages may be increased until no hash collisions occur. If a dynamic hash table cannot be added, adding entries may fail.

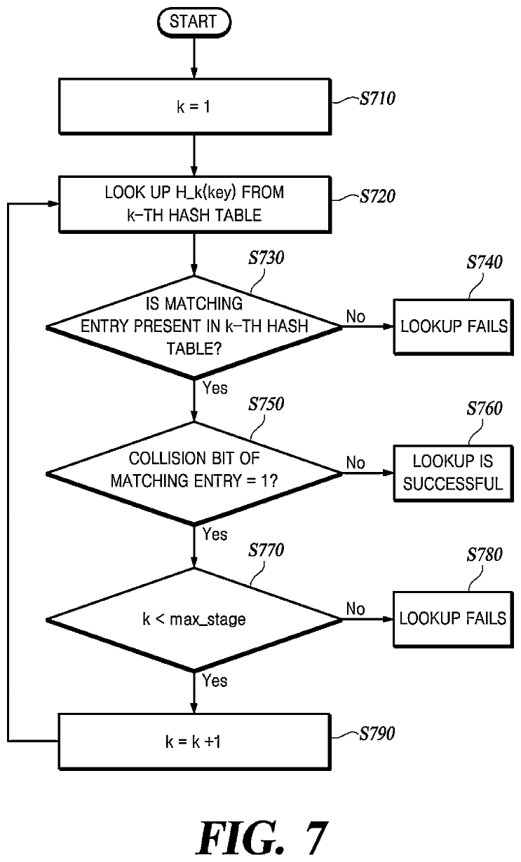

FIG. 7 is a diagram illustrating a process of looking up hash tables according to an embodiment of the present disclosure. For example, since a hash table-based FIB lookup method requires longest prefix matching (LPM), there may be a method of performing lookup multiple times while changing keys. There may be a method of performing lookups on hash tables in multiple stages at once.

Referring to FIG. 7, k may be set to 1 (S710). A lookup may be performed starting from the first hash table. H_k (key) may be looked up from the k-th hash table (S720). It may be determined whether a matching entry is present in the k-th hash table (S730). If there is no matching entry in the k-th hash table (S730—NO), the lookup may fail (S740). If a matching entry is present in the k-th hash table (S730—YES), it may be determined whether the collision bit of the matching entry is 1 (S750). If the collision bit of the matching entry is not 1 (S750—NO), the lookup may be successful (S760). If the collision bit of the matching entry is 1 (S750—YES), it may be determined whether k is less than n, which is the max stage (S770). If k is not less than n (S770—NO), the lookup may fail (S780). If k is less than n (S770—YES), k may be set to k+1 (S790). H_k+1 (key) may be looked up from the (k+1)-th hash table (S720).

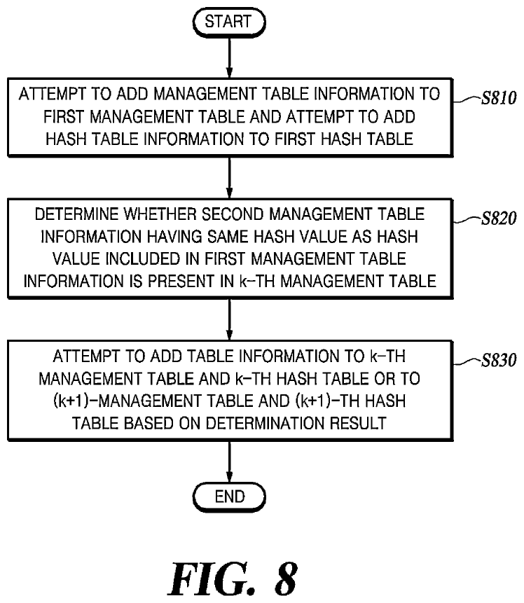

FIG. 8 is a diagram illustrating a method of configuring a multi-stage hash table according to an embodiment of the present disclosure.

Referring to FIG. 8, a device for configuring a multi-stage hash table may attempt to add management table information to the first management table and may attempt to add hash table information to the first hash table (S810). The device for configuring the multi-stage hash table may determine whether second management table information having the same hash value as a hash value included in first management table information is present in the k-th management table (S830). The first management table information may correspond to information to be added to the k-th management table. The device for configuring the multi-stage hash table may attempt to add table information to the k-th management table and the k-th hash table or to the (k+1)-th management table and the (k+1)-th hash table based on the determination result (S830). Table information added to the k-th hash table and the (k+1)-th hash table may not include keys.

The step of adding table information may include a step of adding third management table information and fourth management table information to the (k+1)-management table and adding first hash table information and second hash table information to the (k+1)-th hash table if second management table information having the same hash value as a hash value included in the first management table information is present in the k-th management table. A key included in the first management table information may be the same as a key included in the third management table information, a key included in the second management table information may be the same as a key included in the fourth management table information, and a hash value included in the third management table information and a hash value included in the fourth management table information may correspond to values calculated using the hash function of the (k+1)-th management table. The first hash table information and the second hash table information may include a hash value obtained by hashing a key with a hash function, a value, and a collision bit. The first hash table information and the second hash table information may not include a key.

k may correspond to an integer in a range equal to or greater than 2 and less than n.

The first management table information may include a key, a hash value obtained by hashing the key with a hash function, a value, and a collision bit. The hash function of the k-th management table may be the same as the hash function of the k-th hash table. The step of adding table information may include a step of adding the first management table information to the k-th management table and adding third hash table information to the k-th hash table if the second management table information having the same hash value as the hash value included in the first management table information is not present in the k-th management table. The collision bit included in the first management table information and the collision bit included in the third hash table information may be set to 0. The hash function of the k-th hash table and the hash function of the (k+1)-th hash table may be independent from each other.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method performed by an apparatus for constructing a multi-stage hash table composed of n hash tables and n management tables, the method comprising:
attempting to add management table information to a first management table and attempting to add hash table information to a first hash table;
determining whether second management table information having the same hash value as a hash value included in first management table information is present in a k-th management table, wherein the first management table information is information to be added to the k-th management table; and
attempting to add table information to the k-th management table and a k-th hash table or to a (k+1)-th management table and a (k+1)-th hash table based on the determination result,
wherein table information attempted to add to the k-th hash table and the (k+1)-th hash table does not include a key.

2. The method of claim 1, wherein attempting to add the table information comprises:
attempting to add third management table information and fourth management table information to the (k+1)-th management table and attempting to add first hash table information and second hash table information to the (k+1)-th hash table when the second management table information having the same hash value as the hash value included in the first management table information is present in the k-th management table.

3. The method of claim 2, wherein a key included in the first management table information is the same as a key included in the third management table information,
wherein a key included in the second management table information is the same as a key included in the fourth management table information, and
wherein a hash value included in the third management table information and a hash value included in the fourth management table information are values calculated using a hash function of the (k+1)-th management table.

4. The method of claim 2, wherein the first hash table information and the second hash table information include a hash value obtained by hashing a key with a hash function, a value, and a collision bit, and
wherein the first hash table information and the second hash table information do not include a key.

5. The method of claim 1, wherein k is an integer having a range equal to or greater than 2 and less than n.

6. The method of claim 1, wherein the first management table information includes a key, a hash value obtained by hashing a key with a hash function, a value, and a collision bit.

7. The method of claim 1, wherein a hash function of the k-th management table is the same as a hash function of the k-th hash table.

8. The method of claim 1, wherein attempting to add the table information comprises:
adding the first management table information to the k-th management table and adding third hash table information to the k-th hash table when the second management table information having the same hash value as the hash value included in the first management table information is not present in the k-th management table.

9. The method of claim 8, wherein a collision bit included in the first management table information and a collision bit included in the third hash table information are set to 0.

10. The method of claim 1, wherein a hash function of the k-th hash table and a hash function of the (k+1)-th hash table are independent of each other.

11. An apparatus for constructing a multi-stage hash table composed of n hash tables and n management tables, comprising:
a memory; and
at least one processor,
wherein the at least one processor is configured to:
attempt to add management table information to a first management table and attempt to add hash table information to a first hash table;
determine whether second management table information having the same hash value as a hash value included in first management table information is present in a k-th management table, wherein the first management table information is information to be added to the k-th management table; and
attempt to add table information to the k-th management table and a k-th hash table or to a (k+1)-th management table and a (k+1)-th hash table based on the determination result,
wherein table information attempted to add to the k-th hash table and the (k+1)-th hash table does not include a key.

12. The apparatus of claim 11, wherein the at least one processor is configured to attempt to add third management table information and fourth management table information to the (k+1)-th management table and to attempt to add first hash table information and second hash table information to the (k+1)-th hash table when the second management table information having the same hash value as the hash value included in the first management table information is present in the k-th management table.

13. The apparatus of claim 12, wherein a key included in the first management table information is the same as a key included in the third management table information,
wherein a key included in the second management table information is the same as a key included in the fourth management table information, and
wherein a hash value included in the third management table information and a hash value included in the fourth management table information are values calculated using a hash function of the (k+1)-th management table.

14. The apparatus of claim 12, wherein the first hash table information and the second hash table information include a hash value obtained by hashing a key with a hash function, a value, and a collision bit, and
wherein the first hash table information and the second hash table information do not include a key.

15. The apparatus of claim 11, wherein k is an integer having a range equal to or greater than 2 and less than n.

16. The apparatus of claim 11, wherein the first management table information includes a key, a hash value obtained by hashing a key with a hash function, a value, and a collision bit.

17. The apparatus of claim 11, wherein a hash function of the k-th management table is the same as a hash function of the k-th hash table.

18. The apparatus of claim 11, wherein the at least one processor is configured to add the first management table information to the k-th management table and to add third hash table information to the k-th hash table when the second management table information having the same hash value as the hash value included in the first management table information is not present in the k-th management table.

19. The apparatus of claim 18, wherein a collision bit included in the first management table information and a collision bit included in the third hash table information are set to 0.

20. A computer-readable recording medium storing instructions causing a computer, when executed by the computer, to execute:
attempting to add management table information to a first management table and attempting to add hash table information to a first hash table;
determining whether second management table information having the same hash value as a hash value included in first management table information is present in a k-th management table, wherein the second management table information is information to be added to the k-th management table; and
attempting to add table information to the k-th management table and a k-th hash table or to a (k+1)-th management table and a (k+1)-th hash table based on the determination result,
wherein table information attempted to add to the k-th hash table and the (k+1)-th hash table does not include a key.
